(19) United States
(12) Patent Application Publication
(10) Pub. No.: US 2002/0107988 A1
(43) Pub. Date: Aug. 8, 2002

(54) In-line compression system for low-bandwidth client-server data link

(76) Inventor: James Jordan, Ottawa (CA)

Correspondence Address: MARKS & CLERK, P.O. BOX 957, STATION B, OTTAWA, ON, K1P 5S7, CA

(21) Appl. No.: 09/775,466

(22) Filed: Feb. 5, 2001

(51) Int. Cl. G06F 15/16

(52) U.S. Cl. 709/247; 709/203; 709/218

(57) ABSTRACT

In A method of transferring data from a server to a remote client over a communications link, a request for specific data is sent from the remote client to the server accompanied by a compression request for transmission of the data at a specified compression ratio. Upon receipt of this request, the server retrieves the specific data from a data source, such as a web server or ftp server. An agent at the remote server intercept the retrieved data and compresses at least part of the retrieved data prior to transmission. After transmission to the remote client in compressed form over the communications link in accordance with the compression request, the data is decompressed and restored to an uncompressed intelligible form.

### BACKGROUND OF THE INVENTION

1. Field of the Invention

This invention relates to a method and apparatus for increasing the speed of data transfer over a communications link, for example, the speed of downloading of a web page off the internet.

2. Brief Description of the Prior Art

The internet is now ubiquitous. The desire of content providers to enhance their web pages with graphic-rich content leads to problems for users with low-bandwidth access. There are many internet users who still do not have high-speed access.

Airborne scientific research projects require up-to-date information in flight, such as meteorological and Synthetic Aperture Radar (SAR) experimental data. Typically, the data link operates at a low data rate (4800 BAUD), and consequently long transmission times are required to fend large images, such as weather maps. For example, at this data rate, it takes over 40 minutes to transfer a single one megabyte image.

It is known to compress data to reduce file size by transmission time. There are two fundamental types of data compression; lossless and lossy. Lossless compression employs mathematical algorithms to include the sequence of bits in a more efficient manner, but when the compressed data is decompressed the original file is restored. Lossy compression takes advantage of the fact that human senses are responsive to certain kinds of information more than others. For instance, in the case of images, certain detail can be lost without seriously affecting the user's perception of image quality. Also, certain kinds of detail may not relate to critical information. U.S. Pat. No. 5,666,161 to Kohiyama et al. describes a method of transmitting images over a transmission line wherein the images are compressed prior to transmission. The degree of compression depends on the traffic state of the transmission line. The user has no control over the amount of compression employed.

An object of the invention is to alleviate this problem.

### SUMMARY OF THE INVENTION

According to the present invention there is provided a method of transferring data from a remote server to a remote client over a communications link, comprising sending a request from the remote client to the remote server for specific data accompanied by a compression request for transmission at a specified compression ratio; receiving said request for specific data at the remote server and retrieving said specific data from a data source; providing an agent at the remote server to intercept said retrieved data and compress at least part of said retrieved data prior to transmission in accordance with said compression request; transmitting said retrieved data in compressed form over said communications link to said remote client; and decompressing said compressed data at said remote client to restore said retrieved data to an uncompressed intelligible form.

Typically the data requested will be a web page from the internet, which will be retrieved by the remote server from an internet content server, such as a web server, ftp server, etc. The user specifies the URL of the web page and the degree of compression required. The agent of the remote server then intercepts the data prior to transmission and compresses it to the degree requested by the user. In the preferred embodiment, lossy compression is employed. In this case the user may initially specify a high degree of compression, resulting in significant loss of detail, in order to determine whether the requested material is of interest. If the material does turn out to be of interest, the user can then request that it be re-transmitted with a lower compression ratio, or preferably, if a suitable compression scheme is adopted, have additional components of the compressed image transmitted so as to enhance the detail of the displayed image at the remote client.

The invention is, for example, suitable for use with a 4800 BAUD telephone data link using TCP/IP PPP internetworking protocols. The remote server could be a Windows NT remote access server communicating with a Windows '95/Web browser client. The agent preferably uses a wavelet image compression routine to compress any embedded images larger than the given size threshold. SPIHT image compression is preferred. SPIHT image compression is described by A. Fed and W. A. Pullman in an article entitled “A New and Efficient Image Codec-Based on Set Partitioning in Hierarchical Trees”, IEEE Transactions on Circuits and Systems for Video Tech., June 1966.

Of course, it would be appreciated by those skilled in the art that other types of compression technology, both hardware and software-based, can be employed.

In a further aspect, the invention provides a remote server for transferring data on demand to a remote client over a communications link, comprising a storage medium for storing transferable data; a processing unit for receiving a request from the remote client for specific data accompanied by a compression request for transmission at a specified compression ratio, said processing unit retrieving said data from a data source; an agent running on the remote server for intercepting said data retrieved from said data source and compressing at least part of said retrieved data prior to transmission in accordance with said compression request; and a port on said remote server for transmitting said retrieved data in compressed form over said communications link to said remote client, whereby said compressed data can be decompressed at said remote client to restore said retrieved data to an uncompressed intelligible form.

### BRIEF DESCRIPTION OF THE DRAWINGS

The invention will now be described in more detail, by way of example only, with reference to the accompanying drawings, in which:

FIG. 1 is a schematic diagram of a data transfer system; and

FIG. 2 is an algorithm for performing on-the-fly image compression in accordance with a preferred embodiment of the invention.

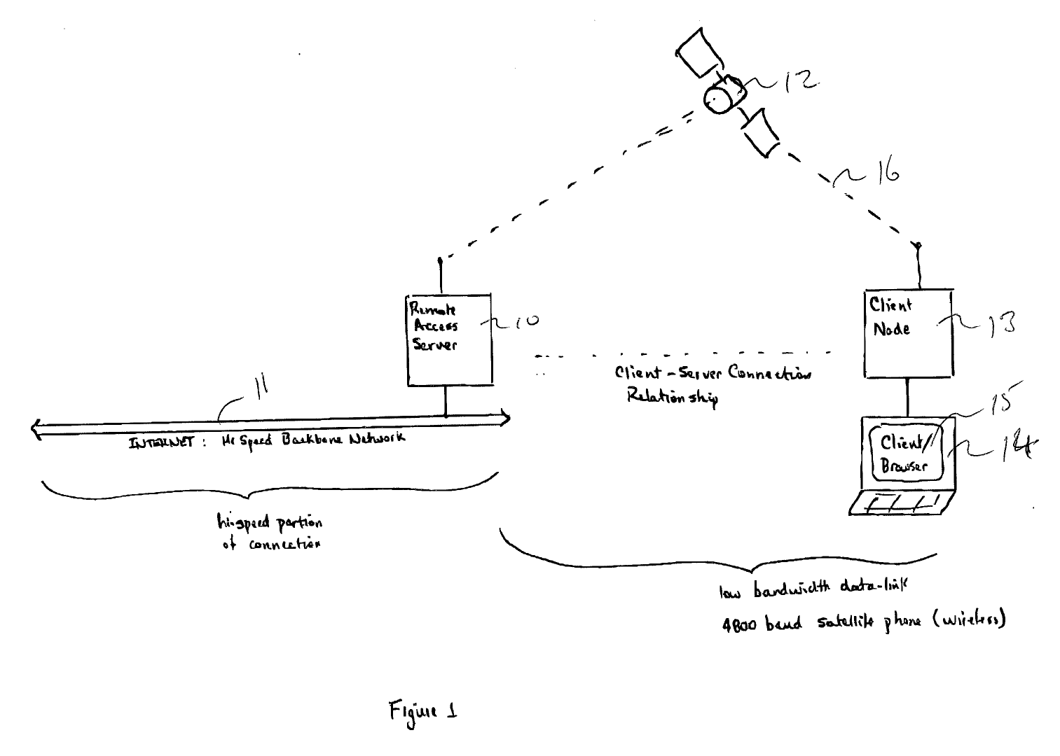

Referring now to FIG. 1, a remote access server 10 is connected to a high-speed backbone network 11, such as the internet. The remote access server 10 communicates via satellite 12 with a client node 13 connected to a computer 14, for example running Windows '95, and including an internet browser 15. The satellite 12 provides a low bandwidth base link 16, typically at 4800 BAUD.

The role of the remote access server 10 is to receive requests from the client browser 15 for internet web pages at a specific URL (Uniform Resource Locate) and after retrieving the requested pages transmit the data over the wireless link 16 to the client node 34 and display on the client browser 15.

As noted above, web pages are typically rich in graphic content. Large images take too long to transmit over the low bandwidth link 16, and in many cases the images contain information that is either of little value to the end user or contains more detail than is required by the end user.

In accordance with the principals of the invention, the user interacts with an initial server-based web page form by entering the desired URL, working directory, the compression procedure compression ratio and smoothing factor. If desired, the compression parameters can be said to default to standard values.

A CGI-based perl script on the server 10 retrieves the specified web content and calls the wavelet image compression routine to compress any embedded images over a certain size. A second link in the browser page called a batch procedure (perl script) on the client computer 14 to transfer by FTP (File Protocol) the compressed data across the low bandwidth data-link 16 for storage in a temporary directory. This then calls the decompression procedure in the client computer 15 to generate replicas of the original images in the web page.

A third link to the temporary directory in the client computer 15 allows the final images to be displayed.

In a preferred embodiment, the above three steps might be replaced by a browser plug-in that would permit the steps to be performed in response to a single mouse-click.

The advantage of this process is that it allows user interaction. For example, the compression ratio and URL can be selected and re-transmission carried out if the image quality is inadequate. The browser can also select a region of interest, such as a particular weather system on a meteorological satellite image, to reduce the size of the original image that needs to be transferred.

The performance of the system depends on the attainable compression ratio of the wavelet compression software while providing adequate image quality for the user's application and the amount of time required to compress and decompress images using typical software procedures. Currently, about 30 seconds is required for a 336-kilobyte image using a 33 megahertz 486 server processor and a 90 megahertz pentium client side processor. This time can be significantly reduced using the more powerful computers currently available on the market.

The degree of image compression that can be employed depends to a large extent on the content of the image. However, ratios of up to 20:1 can give usable results for large images with considerable textual information, thereby reducing data transmission times by up to 38 minutes for the 1-megabyte image referred to previously. Generally, there will be a tradeoff since the time to compress/decompress small images may exceed the uncompressed transmission time. The threshold for file size is estimated to be in the order of 15 kilobytes, and the system can be set so that images having a file size smaller than this are not compressed.

An auxiliary digital signal processor or firmware can be used to speed up the compression/decompression if higher performance is required.

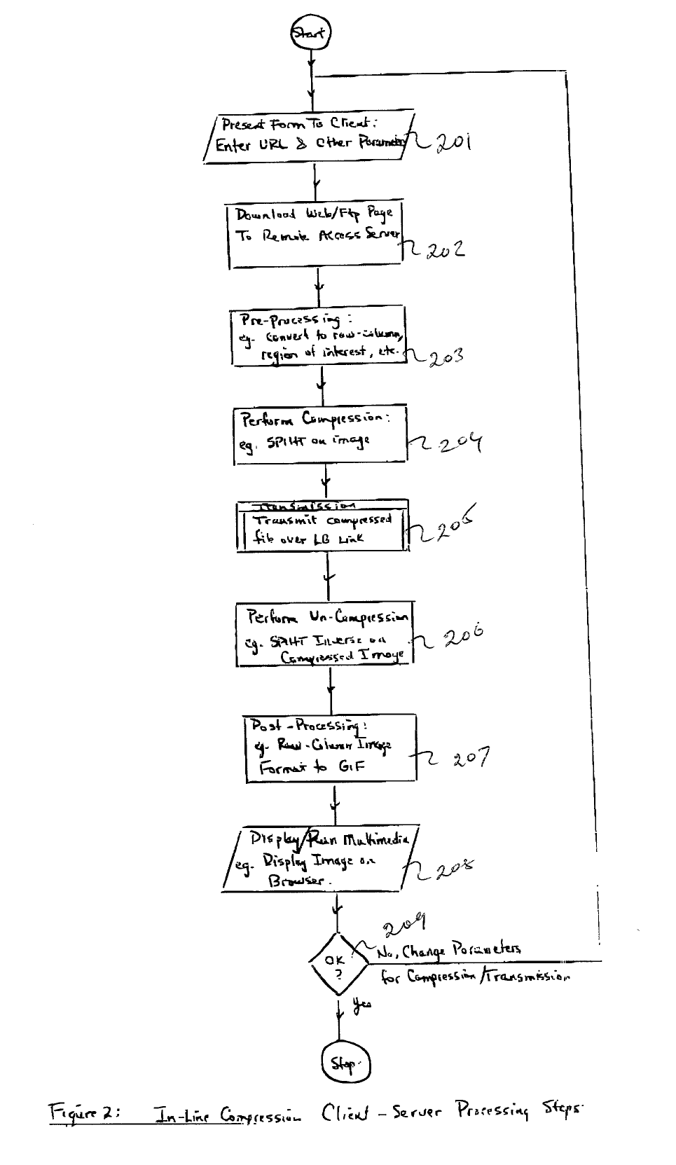

FIG. 2 shows in detail the algorithm for implementing the preferred embodiment of the invention. A step 201 form is presented to the client on browser 15 inviting entry of the desired URL and compression parameters. In step 202, the remote access server 10 retrieves the identified web page via FTP. Alternatively, a Perl procedure generally an agent procedure of some kind can be employed. In step 203, the remote access server can perform pre-processing of the data prior to transmission. Such pre-processing could involve conversion to row and column format, and identification of regions of interest for example.

Subsequently, in step 204 SPIHT compression is performed on the data to be transmitted. This is a lossy compression technique wherein the amount of detail lost depends on the nature of the image and the compression ratio.

The data is then transmitted at step 205 over the low bandwidth link 16 to the client node 30 and transferred to client computer 14. This performs, at step 206, a decompression of the compressed data, i.e. an inverse SPIHT operation, to retrieve the original image, possibly with a lot of detail depending on the compression parameters.

Step 207, post-processing is performed on the decompressed image, for example to convert the image to a standard image file format, such as a GIF format. Next, step 208, the image just received is displayed on the browser 15 as part of a web page.

A decision step 209, the user is asked whether the retrieved image is satisfactory. If so, the process stops, otherwise the image is re-transmitted with change parameters or alternatively in the preferred embodiment, additional compression components can be transmitted in order to supply additional detail to the previously transmitted image.

One of the advantages of wavelet compression is that the image is represented by components in a hierarchical fashion that can be progressively discarded. Each component that is discarded results in additional loss of detail, but if the detail in the decompressed image is insufficient, a request can be sent for additional components so as to increase the level of detail present in the retrieved image. This does not necessitate re-transmission that the components, carrying the coarser information, that have already been transmitted.

The system is particularly useful for all downloads of data, such as weather data, from the internet to aircraft in flight. It allows, for example, the downloading of weather radar and satellite images for meteorological projects giving near real-time access to the weather information available on the internet and meteorological intranets. The system can also be used in reverse for downloading image information from aircraft to earth using an FTP server on the aircraft.

The described system is flexible and well suited to the wide variety of multi-media formats used on the internet. While it has been described in the connection with the transfer of images, it will be appreciated that the same technique can also be applied to the transfer of other multi-media formats, such as video.

We claim:

1. A method of transferring data from a remote server to a remote client over a communications link, comprising:
sending a request from the remote client to the remote server for specific data accompanied by a compression request for transmission at a specified compression ratio;
receiving said request for specific data at the remote server and retrieving said specific data from a data source;
providing an agent at the remote server to intercept said retrieved data and compress at least part of said retrieved data prior to transmission in accordance with said compression request;
transmitting said retrieved data in compressed form over said communications link to said remote client; and
decompressing said compressed data at said remote client to restore said retrieved data to an uncompressed intelligible form.

2. A method as claimed in claim 1, wherein said agent compresses image portions of said data.

3. A method as claimed in claim 2, wherein said image portions are compressed using a lossy compression algorithm.

4. A method as claimed in claim 3, wherein said lossy compression algorithm comprises a discrete wavelet transform.

5. A method as claimed in claim 2, wherein said images are compressed using a lossless compression algorithm.

6. A method as claimed in claim 1, wherein said remote client sends at least one further request for all or part said specific data at a reduced compression ratio.

7. A method as claimed in claim 6, wherein said client sends a request for an identified portion of said data at a reduced compression ratio.

8. A method as claimed in claim 7, wherein said specific data comprises a web page stored on a web server providing said data source.

9. A method as claimed in claim 8, wherein said identified portion comprises a portion of an image forming part of said web page.

10. A remote server for transferring data on demand to a remote client over a communications link, comprising:
a storage medium for storing transferable data;
a processing unit for receiving a request from the remote client for specific data accompanied by a compression request for transmission at a specified compression ratio, said processing unit retrieving said data from a data source;
an agent running on the remote server for intercepting said data retrieved from said data source and compressing at least part of said retrieved data prior to transmission in accordance with said compression request; and
a port on said remote server for transmitting said retrieved data in compressed form over said communications link to said remote client, whereby said compressed data can be decompressed at said remote client to restore said retrieved data to an uncompressed intelligible form.

11. A remote server as claimed in claim 10, wherein said agent compresses image portions of said data.

12. A remote server as claimed in claim 10, wherein said agent employs a lossy compression algorithm.

13. A remote server as claimed in claim 12, wherein said lossy compression algorithm comprises a discrete wavelet transform.

14. A remote server as claimed in claim 10, wherein said agent employs a lossless compression algorithm.

15. A remote server as claimed in claim 10, wherein said remote server is responsive to at least one further request from said remote client for all or part said specific data at a reduced compression ratio.

16. A remote server as claimed in claim 15, wherein said remote server is responsive to a request from said remote client for an identified portion of said data at a reduced compression ration.

17. A remote server as claimed in claim 10, wherein said processing unit retrieves said data from a an Internet content server providing said data source.
